(19) United States
(12) Patent Application Publication
(10) Pub. No.: US 2014/0295848 A1
(43) Pub. Date: Oct. 2, 2014

(54) METHOD AND APPARATUS FOR SELECTING FREQUENCY FOR CALL REDIRECTION IN A MOBILE COMMUNICATION SYSTEM

(71) Applicant: Samsung Electronics Co., Ltd., Suwon-si (KR)

(72) Inventors: Seung-Wook HONG, Suwon-si (KR); Seong-Wook SONG, Seoul (KR); In-Yup KANG, San Diego, CA (US); Sang-Tae KIM, Suwon-si (KR); Da-Hae CHONG, Suwon-si (KR)

(73) Assignee: Samsung Electronics Co., Ltd., Suwon-si (KR)

(21) Appl. No.: 13/966,936

(22) Filed: Aug. 14, 2013

(30) Foreign Application Priority Data
Mar. 28, 2013 (KR) 10-2013-0033751

(51) Int. Cl. H04W 36/00

(52) U.S. Cl. CPC H04W 36/0083
USPC 455/437

(57) ABSTRACT

A communication method of a mobile terminal for reliably performing call redirection between heterogeneous or homogeneous mobile communication systems is provided. The communication method includes requesting a first base station of a first mobile communication system to establish a call connection, receiving information about a first frequency of an adjacent base station for call redirection from the first base station in response to the call connection request, searching for one or more frequencies for the call redirection using the information about the first frequency and information about a second frequency of at least one second mobile communication system, selecting a frequency for the call redirection from among the searched frequencies, and sending a call connection request to a second base station using the selected frequency.

### CROSS-REFERENCE TO RELATED APPLICATION(S)

This application claims the benefit under 35 U.S.C. §119(a) of a Korean patent application filed on Mar. 28, 2013 in the Korean Intellectual Property Office and assigned Serial No. 10-2013-0033751, the entire disclosure of which is hereby incorporated by reference.

### TECHNICAL FIELD

The present disclosure relates to a radio transceiver. More particularly, the present disclosure relates to a method and apparatus for selecting a frequency for call setup.

### BACKGROUND

With advances in communication technology, mobile communication systems have evolved to high-speed, high-quality wireless packet data communication systems that provide data services and multimedia services in addition to voice-based services. Lately, various mobile communication systems have been introduced, such as High Speed Downlink Packet Access (HSDPA), High Speed Uplink Packet Access (HSUPA), Long Term Evolution (LTE), and Long Term Evolution Advanced (LTE-A), which are defined by the 3^{rd} Generation Partnership Project (3GPP), and High Rate Packet Data (HRPD) which is defined by the 3^{rd} Generation Partnership Project 2 (3GPP2). These systems evolved from a Code Division Multiple Access (CDMA) network that provides 2^{nd} generation mobile communication services and have been developed in order to support high-speed, high-quality wireless packet data transmission services.

Accordingly, various mobile communication systems, including 2^{nd} generation systems such as CDMA systems, LTE systems, and 4^{th} generation systems coexist and use heterogeneous networks in the same space. In such a heterogeneous wireless environment, each mobile communication system is independently managed. Accordingly, if an overload occurs or an abnormal state in which there are insufficient codes, power, or communication resources to be allocated occurs in a mobile communication system to which a mobile terminal is currently connected to or tries to connect, the mobile communication system performs so-called call redirection to hand over a call of the corresponding mobile terminal to an adjacent mobile communication system.

In call redirection between heterogeneous mobile communication systems, if an abnormal state occurs when a base station of a first mobile communication system has received a call connection request (hereinafter, simply referred to as a “call request”) from a mobile terminal, the base station transmits information about a frequency of a base station of an adjacent second mobile communication system to the mobile terminal. Then, the mobile terminal searches for the corresponding frequency, and sends a call request to the base station of the second mobile communication system for call redirection. At this time, if the mobile terminal fails to find the base station of the second mobile communication system for call redirection, the mobile terminal searches for another frequency, and if the other frequency no longer exists, the call connection fails.

Accordingly, when the mobile terminal is moving, the base station of the first mobile communication system will have difficulties in selecting an optimal base station for call redirection among the base stations of an adjacent heterogeneous mobile communication system (hereinafter, simply referred to as a “heterogeneous system”). In this case, it is difficult for the mobile terminal to reliably perform call redirection, and cases in which a call connection fails or Quality-of-Service (QoS) deteriorates often occur.

Hereinafter, problems caused upon call redirection between heterogeneous systems of the related art will be described with reference to FIGS. 1 and 2.

FIG. 1 illustrates an example in which a call connection fails due to movement of a mobile terminal upon call redirection between heterogeneous systems according to the related art. In more detail, FIG. 1 illustrates an example in which, after a mobile terminal 10 moving (M1) in a cell-edge region requests a base station 20a of a first mobile communication system 100 to establish a call connection, a call connection between the mobile terminal 10 and base stations 20b and 20c of second mobile communication systems 200a and 200c to which the call will be redirected fails.

Referring to FIG. 1, the mobile terminal 10 requests the base station 20a of the first mobile communication system 100 to establish a call connection while mobile terminal 10 is moving at operation 101. At this time, if the base station 20a determines that an abnormal state incapable of establishing the call connection has occurred, the base station 20a transmits information about a frequency (for example, a first frequency) of the base station 20b of the adjacent heterogeneous system selected for call redirection to the mobile terminal 10 at operation 103. Then, the mobile terminal 10 searches for the first frequency based on the information about the frequency, and requests the base station 20b to establish a call connection at operation 105.

However, if the mobile terminal 10 moves out of the cell coverage of the base station 20b before it receives a response to the call connection request, the mobile terminal 10 cannot receive a call admission from the base station 20b at operation 107 so that the call connection of the mobile terminal 10 for call redirection fails at operation 109.

FIG. 2 illustrates another example in which a call connection fails due to movement of a mobile terminal upon call redirection between heterogeneous systems according to the related art. In more detail, FIG. 2 illustrates another example in which, after a mobile terminal 10 moving (M1) in a cell-edge region requests a base station 20a of a first mobile communication system 100 to establish a call connection, a call connection between the mobile terminal 10 and base stations 20b and 20c of second mobile communication systems 200a and 200c to which the call will be redirected fails.

In the example of FIG. 2, operations 201 through 205 are the same as operations 101 through 105 of FIG. 1. The situation illustrated in FIG. 2 corresponds to a case in which the mobile terminal 10 continues to move and thus is no longer within the cell coverage of the base station 20b although the mobile terminal 10 has received a call admission at operation 207 after requesting the base station 20b to establish a call connection at operation 205, so that a call connection between the mobile terminal 10 and the base station 20b fails at operation 209.

Accordingly, a method of reliably transferring a call between heterogeneous systems while a mobile terminal is moving is needed.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for selecting a frequency for reliable call redirection in a mobile communication system.

Another aspect of the present disclosure is to provide a base station capable of supporting reliable call redirection, and a method thereof.

In accordance with an aspect of the present disclosure, a communication method of a mobile terminal in a mobile communication system is provided. The communication method includes requesting a first base station of a first mobile communication system to establish a call connection, receiving information about a first frequency of an adjacent base station for call redirection from the first base station in response to the call connection request, searching for one or more frequencies for the call redirection using the information about the first frequency and information about a second frequency of at least one second mobile communication system, selecting a frequency for the call redirection from among the searched frequencies, and sending a call connection request to a second base station using the selected frequency.

In accordance with another aspect of the present disclosure, a mobile terminal for call redirection in a mobile communication system is provided. The mobile terminal includes a transceiver configured to receive/transmit radio signals from/to a plurality of base stations, and a controller configured to request a first base station of a first mobile communication system to establish a call connection, to receive information about a first frequency of an adjacent base station for call redirection from the first base station in response to the call connection request, to search for one or more frequencies for the call redirection using the information about the first frequency and information about a second frequency of at least one second mobile communication system, to select a frequency for the call redirection from among the searched frequencies, and to send a call connection request to a second base station using the selected frequency.

In accordance with another aspect of the present disclosure, a communication method of a base station in a mobile communication system is provided. The communication method includes receiving a call request for establishing a call connection from a mobile terminal, and transmitting information about a first frequency of an adjacent base station for call redirection of the mobile terminal and information about a second frequency of at least one mobile communication system, to the mobile terminal, if an abnormal state incapable of establishing the call connection has occurred.

In accordance with another aspect of the present disclosure, a base station of a mobile communication system is provided. The base station includes a transceiver configured to receive/transmit radio signals from/to a mobile terminal, and a controller configured to receive a call request for establishing a call connection from the mobile terminal, and to control operation of transmitting information about a first frequency of an adjacent base station for call redirection of the mobile terminal and information about a second frequency of at least one second mobile communication system, to the mobile terminal, if an abnormal state incapable of establishing the call connection has occurred.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain various embodiments of the present disclosure will be more apparent from the following description taken in conjunction with the accompanying drawings, in which:

FIGS. 1 and 2 illustrate examples in which a call connection fails due to movement of a mobile terminal upon call redirection between heterogeneous systems according to the related art;

FIG. 3 is a flowchart illustrating a method for selecting a frequency for call redirection between heterogeneous systems according to an embodiment of the present disclosure;

FIG. 4 is a view illustrating an example of a process of selecting a frequency for call redirection between heterogeneous systems according to an embodiment of the present disclosure;

FIG. 5 is a flowchart illustrating a method for selecting a frequency for call redirection between heterogeneous systems according to an embodiment of the present disclosure; and

FIG. 6 is a view illustrating an example of a process of selecting a frequency for call redirection between heterogeneous systems according to an embodiment of the present disclosure.

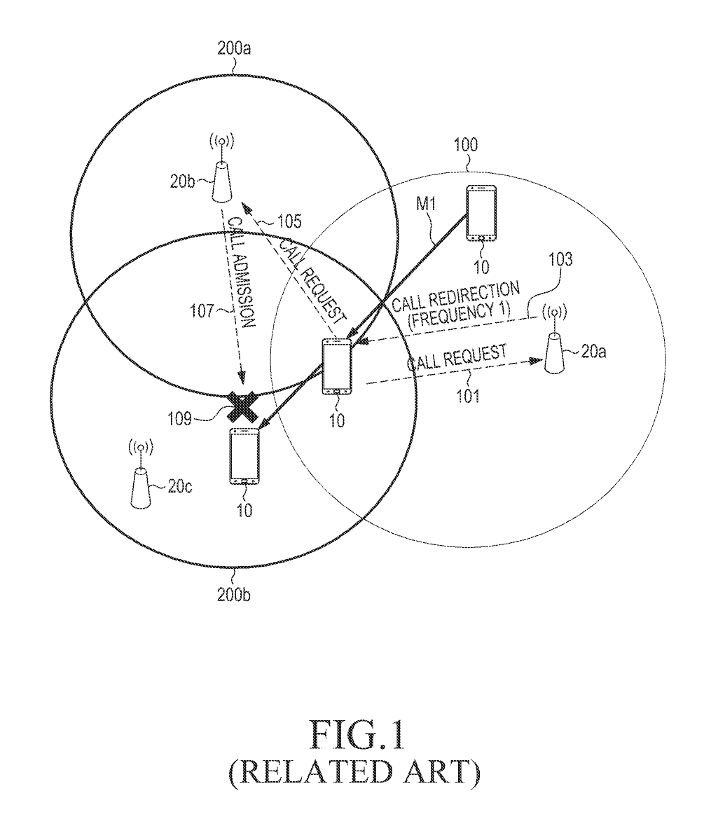

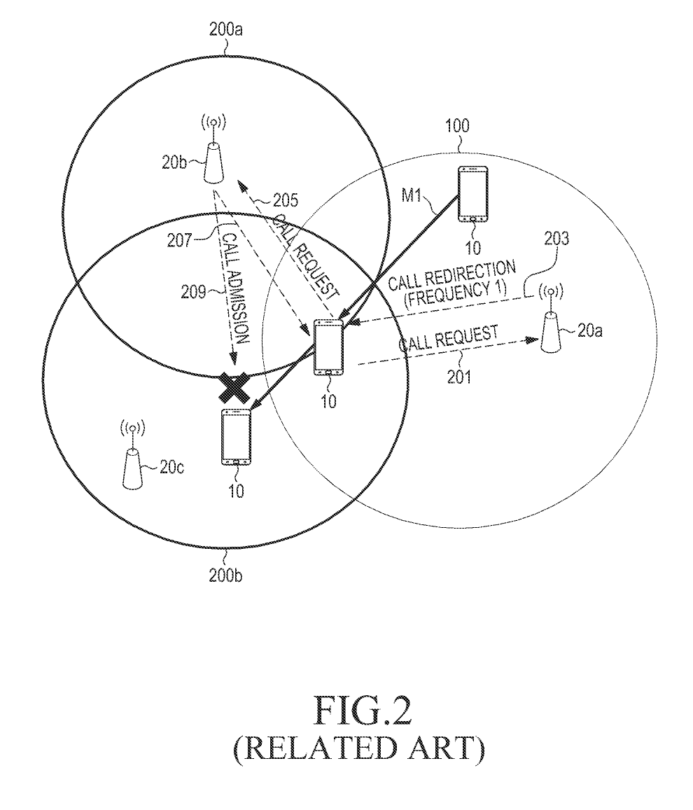

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As described above, according to a method for call redirection of a mobile terminal between heterogeneous systems of the related art, when a call request is sent from a mobile terminal and call redirection is needed, a base station which has received the call request provides the mobile terminal with information about a frequency of a base station selected from among adjacent heterogeneous systems, and the mobile terminal uses only the information about the frequency to search for the frequency of the base station to which the call will be redirected.

A method for call redirection of a mobile terminal according to an embodiment of the present disclosure is the substantially same as the method of the related art in that, when a mobile terminal requests a call and call redirection is needed, a base station which has received the call request provides the mobile terminal with information about a frequency (hereinafter, information about a first frequency) of a base station selected from among adjacent heterogeneous systems. However, according to an embodiment of the present disclosure, the mobile terminal uses information about an additional frequency (hereinafter, referred to as a second frequency) together with the received information about the first frequency to search for the frequency of the base station to which the call will be redirected. Here, the information about the second frequency includes at least one piece of information among at least one piece of information about frequencies previously used for call connections by the corresponding mobile terminal and at least one piece of information about frequencies being used by the operator of an adjacent heterogeneous system.

Accordingly, in an embodiment of the present disclosure, the mobile terminal that performs call redirection selects a base station with high intensity and good quality of reception signal based on frequencies detected using both the information about the first frequency and the information about the second frequency, and again sends a call request for call redirection to the selected base station.

Since a mobile communication system uses a limited frequency band, a mobile terminal can probabilistically search for most frequencies of regions to which it moves if the mobile terminal stores and reuses information about previously used frequencies. Also, according to the call redirection as described above, the mobile terminal can select a base station with the highest intensity of reception signal or the best quality of reception signal for call redirection from a relatively extended frequency band, thereby making it possible to significantly reduce frequency at which a call connection fails or Quality of Service (QoS) deteriorates.

Hereinafter, a configuration and operation of a mobile terminal and a base station for call redirection between heterogeneous systems, according to various embodiments of the present disclosure, will be described. However, the various embodiments of the present disclosure can be applied to call redirection between different base stations in the same mobile communication system.

In this case, when an abnormal state requiring call redirection occurs, a base station which has received a call request from a mobile terminal provides the mobile terminal with information about a first frequency of a base station selected in the same mobile communication system and information about a second frequency of at least one adjacent base station, and the mobile terminal performs an operation of selecting a frequency for call redirection using the information about the first and second frequencies.

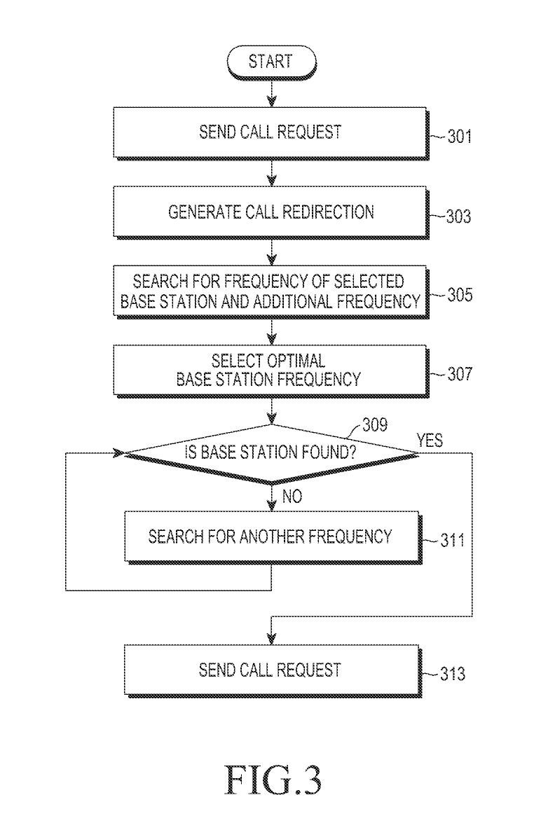

FIG. 3 is a flowchart illustrating a method for selecting a frequency for call redirection between heterogeneous systems according to an embodiment of the present disclosure.

Referring to FIG. 3, a mobile terminal sends a call request to a first base station of a first mobile communication system while moving at operation 301. If the first base station determines that an abnormal state incapable of establishing a call connection has occurred, the first base station transmits information about a first frequency of a second base station of an adjacent heterogeneous system selected for call redirection, together with a message for notifying the generation of call redirection, to the mobile terminal. The mobile terminal which has received the message for notifying the generation of call redirection and the information about the first frequency of the second base station determines that call redirection to the frequency of the base station (the second base station) selected for call redirection has been generated at operation 303.

The mobile terminal uses information about second frequencies including at least one of at least one piece of information about frequencies previously used for call connections and at least one piece of information about frequencies being used by the operator of an adjacent heterogeneous system, in addition to the information about the first frequency of the second base station, to search for the frequencies of the respective corresponding base stations at operation 305, and selects an optimal base station frequency, that is, a frequency with the highest intensity of reception signal or the best quality of reception signal, from among frequencies searched at the current location of the mobile terminal at operation 307.

Successively, the mobile terminal searches for a base station using the optimal base station frequency at operation 309, and if the corresponding base station is not found, the mobile terminal again performs operation 307 excluding the optimal base station frequency to search for and select another frequency at operation 311, and then again performs operation 309. If a base station using the finally selected frequency is found, the mobile terminal sends a call request for call redirection to the base station using the finally selected frequency at operation 313. If a frequency to be searched no longer exists when operation 311 is repeatedly performed, or if no base station using the selected frequency is found, the mobile terminal considers it as a call connection failure, which is not illustrated in FIG. 3.

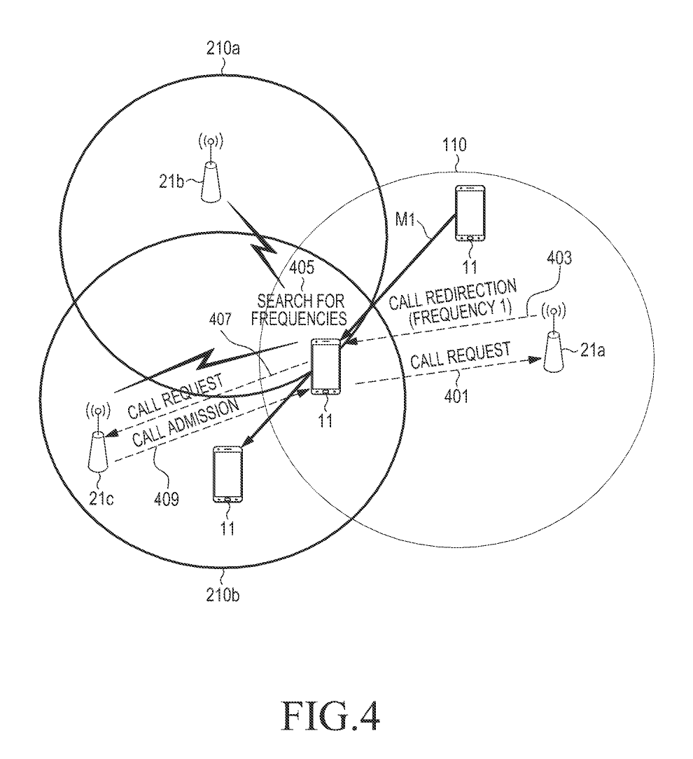

FIG. 4 is a view illustrating an example of a process of selecting a frequency for call redirection between heterogeneous systems according to an embodiment of the present disclosure. In more detail, FIG. 4 illustrates an example in which, when call redirection has occurred after a mobile terminal 11 moving (M1) in a cell-edge region requests a first base station 21a of a first mobile communication system 110 to establish a call connection, the mobile terminal 11 searches for frequencies of base stations 21b and 21c of second mobile communication systems 210a and 210b based on information about first and second frequencies as described above, and selects the base station 21c using a frequency with the highest intensity of signal or the best quality of signal among the found frequencies to thus perform call redirection.

Referring to FIG. 4, the mobile terminal 11 sends a call request to the first base station 21a of the first mobile communication system 110 while moving at operation 401. If the first base station 21a determines that an abnormal state incapable of establishing a call connection has occurred, the first base station 21a transmits information about a first frequency (for example, a frequency 1) of the base station 21b of an adjacent heterogeneous system selected for call redirection to the mobile terminal 11 at operation 403. At this time, a message for notifying of the generation of call redirection may be also transmitted to the mobile terminal 11. However, the mobile terminal 11 may recognize the generation of call redirection only by receiving the information about the first frequency.

The mobile terminal 11 searches for all frequencies being used by the base stations 21b and 21c of the adjacent heterogeneous systems 210a and 210b, based on information about second frequencies including at least one piece of information among information about frequencies previously used for call connections by the mobile terminal 11 at the current location of the mobile terminal 11 and information about frequencies being used by the operators of the adjacent heterogeneous systems 210a and 210b, in addition to the information about the first frequency at operation 405. If the base station 21c using an optimal frequency for call redirection is found, the mobile terminal 11 sends a call request for call redirection to the base station 21c using the corresponding frequency at operation 407. The mobile terminal 11 receives a call admission from the base station 21c in response to the call request, thereby successfully completing call redirection at operation 409.

Although not illustrated in the drawings, a mobile terminal according to an embodiment of the present disclosure may be implemented to include a transceiver for receiving/transmitting radio signals from/to base stations, and a controller for controlling the operations illustrated in FIG. 3. In this case, the controller may control operations of sending a call connection request to a first base station of a first mobile communication system, receiving information about a first frequency of an adjacent base station for call redirection from the first base station in response to the call connection request, searching for frequencies for call redirection using the information about the first frequency and information about a second frequency of at least one second mobile communication system, selecting a frequency for call redirection from among the found frequencies, and sending a call connection request to a second base station using the selected frequency. Also, the mobile terminal may further include a measurer for measuring the intensity of reception signals upon selecting of the frequency.

Meanwhile, the above-described various embodiments relate to an example in which a mobile terminal collects, stores, and uses the information about the second frequencies. However, the mobile terminal may receive at least one piece of information among the information about the second frequencies from a base station which has notified the generation of call redirection.

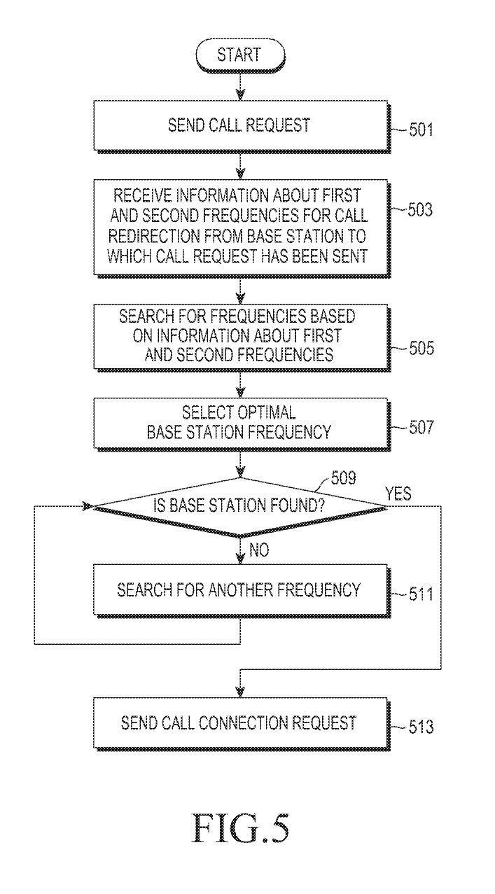

FIG. 5 is a flowchart illustrating a method for selecting a frequency for call redirection between heterogeneous systems according to an embodiment of the present disclosure.

Referring to FIG. 5, a mobile terminal sends a call request to a first base station of a first mobile communication system while moving at operation 501. If the first base station determines that an abnormal state incapable of establishing a call connection has occurred, the first base station transmits information about a first frequency of a second base station of a second mobile communication system selected by the first base station and information about a second frequency of at least one third base station except for the second base station, to the mobile terminal, and the mobile terminal receives the information about the first and second frequencies from the base station at operation 503. The at least one third base station may be a base station belonging to the second mobile communication system or a base station belonging to another heterogeneous communication system. Also, the information about the first and second frequencies may be provided in the form of a frequency list.

The mobile terminal searches for one or more frequencies being used by base stations of at least one adjacent heterogeneous system based on the information about the first and second frequencies at operation 505, and selects an optimal base station frequency, that is, a frequency with the highest intensity of reception signal or the best quality of reception signal, from among the found frequencies at operation 507. The mobile terminal searches for a base station using the selected, optimal base station frequency at operation 509. If no base station using the optimal base station frequency is found, operation 507 excluding the selected, optimal base station frequency is again performed to search for and select another frequency at operation 511, and operation 509 is again performed. If a base station using a frequency finally selected by the operations is found, the mobile terminal sends a call request for call redirection to the base station using the finally selected frequency at operation 513.

As another embodiment, the mobile terminal may perform operation 505 of searching for frequencies based on information about one or more frequencies previously used for call connections by the mobile terminal, in addition to the information about the first and second frequencies received from the first base station, like the embodiment illustrated in FIG. 3.

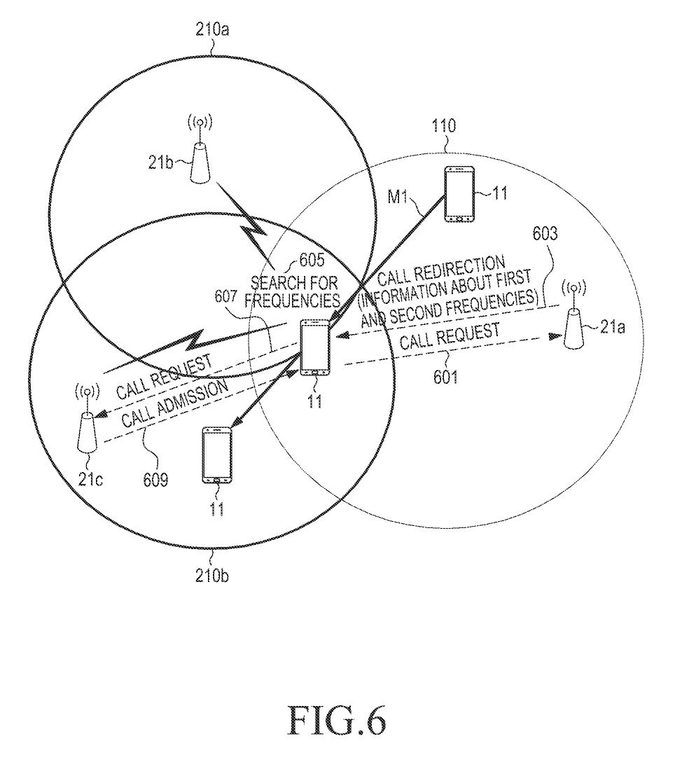

FIG. 6 is a view illustrating an example of a process of selecting a frequency for call redirection between heterogeneous systems according to an embodiment of the present disclosure. In more detail, FIG. 6 illustrates an example in which, when call redirection has occurred after a mobile terminal 11 moving (M1) in a cell-edge region requests a first base station 21a of a first mobile communication system 110 to establish a call connection, the mobile terminal 11 searches for the frequencies of base stations 21b and 21c of second mobile communication systems 210a and 210b based on information about first and second frequencies received from the first base station 21a, and selects the base station 21c using a frequency with the highest intensity of signal or the best quality of signal among the found frequencies to thus perform call redirection.

Referring to FIG. 6, the mobile terminal 11 sends a call request to the first base station 21a of the first mobile communication system 110 while moving at operation 601. If the first base station 21a determines that an abnormal state incapable of establishing a call connection has occurred, the first base station 21a transmits information about a first frequency of the base station 21b of the adjacent heterogeneous system 210a selected by the first base station 21a for call redirection of the mobile terminal 21a, and information about the second frequency of the base station 21c of the adjacent heterogeneous system 210b, to the mobile terminal 11 at operation 603. Here, the information about the second frequency may include information about a frequency being used by the operator of the adjacent heterogeneous system 210b. The information about the first and second frequencies may be provided in the form of a frequency list, and also provided together with a message for notifying of the generation of call redirection. However, the mobile terminal 11 may recognize the generation of call redirection only by receiving the information about the first frequency.

The mobile terminal 11 searches for frequencies being used by the base stations 21b and 21c of the adjacent heterogeneous systems 210a and 210b based on the information about the first and second frequencies at operation 605. If the base station 21c using an optimal frequency for call redirection among the found frequencies is found, the mobile terminal 11 sends a call request for call redirection to the base station 21c using the corresponding frequency at operation 607. At operation 609, the mobile terminal 11 receives a call admission from the base station 21c in response to the call request, thereby successfully completing call redirection.

Meanwhile, in the embodiment as described above, the call redirection may be defined as a case in which information about a frequency for a call connection to a heterogeneous system or a homogeneous system is included in a message associated with a Radio Resource Control (RRC) connection that is transmitted to a mobile terminal from a base station of a 3^{rd} Generation Partnership Project (3GPP) based communication system, such as a Wideband-Code Division Multiple Access (W-CDMA) system, a Long Term Evolution (LTE) system, etc. The information about the frequency may include the information about the first frequency or the information about both the first and second frequencies.

Here, the message associated with the RRC connection may be an RRC Connection Setup message, an RRC Connection Reject message, an RRC Connection Release message, etc.

When the call redirection is performed between homogeneous systems, all of the RRC Connection Setup message, the RRC Connection Reject message, and the RRC Connection Release message may be used. In this case, the information about the frequency may be included in the form of “frequency info” in the RRC Connection Setup message, the RRC Connection Reject message, and the RRC Connection Release message.

When the call redirection is performed between heterogeneous systems, the RRC Connection Reject message or the RRC Connection Release message may be used. In this case, the information about the frequency may be included in the form of “inter-RAT Info” in Redirection Info included in the RRC Connection Reject message or the RRC Connection Release message.

Accordingly, in the current embodiment, the call redirection may be understood as redirecting a call connection of a mobile terminal between heterogeneous systems or between homogeneous systems using a message associated with an RRC connection.

The following Table 1, Table 2, and Table 3 illustrate examples of an RRC Connection Setup message, an RRC Connection Reject message, and an RRC Connection Release message in a 3GPP-based communication system.

TABLE 1
RRC Connection Setup

1> Reception of an RRC CONNECTION SETUP
message by the UE
2> if the UE will be in the CELL_FACH state at
the conclusion of this procedure:
3> if the IE “Frequency info” is included:
4> select a suitable UTRA cell on that frequency.

| PhyCH | | | | |
|---|---|---|---|---|
| information elements | | | | |
| Frequency info | OP | Frequency | | |
| | | info | | |
| | | 10.3.6.36 | | |
| Multi-frequency Info | OP | Multi- | This IE is | REL-7 |
| | | frequency | used for 1.28 | |
| | | Info | Mcps TDD only | |
| | | 10.3.6.39a | | |
| DTX-DRX | OP | DTX-DRX | | REL-7 |
| timing information | | timing | | |
| | | information | | |
| | | 10.3.6.34b | | |
| DTX-DRX | OP | DTX-DRX | | REL-7 |
| Information | | Information | | |
| | | 10.3.6.34a | | |
| HS-SCCH | OP | HS-SCCH | | REL-7 |
| less Information | | less | | |
| | | Information | | |
| | | 10.3.6.36ab | | |
| SPS Information | OP | SPS | This IE is | REL-8 |
| | | information | used for 1.28 | |
| | | 1.28 Mcps | Mcps TDD only | |
| | | TDD | | |
| | | 10.3.6.110 | | |

TABLE 2
RRC Connection Reject

Reception of an RRC CONNECTION REJECT message by the UE
1> if the IE “frequency info” is present and:
2> if V300 is equal to or smaller than N300:
3> select a suitable UTRA cell on that frequency;

| Information | | | Type and | Semantics | |
|---|---|---|---|---|---|
| Element/Group name | Need | Multi | reference | description | Version |
| Message Type | MP | | Message Type | | |
| UE information | | | | | |
| elements | | | | | |
| RRC transaction | MP | | RRC transaction | | |
| identifier | | | identifier | | |
| | | | 10.3.3.36 | | |
| Initial US identity | MP | | Initial UE identity | | |
| | | | 10.3.3.15 | | |
| Rejection cause | MP | | Rejection cause | | |
| | | | 10.3.3.31 | | |
| Wait time | MP | | Wait time | | |
| | | | 10.3.3.50 | | |
| Redirection info | OP | | Redirection info | The US shall ignore | |
| | | | 10.3.3.29 | any unsupported | |
| | | | | frequencies included | |
| | | | | in this IE. | |
| Counting | OP | | Enumerated | This field may be | REL-6 |
| completion | | | (TRUE) | present if the Rejection | |
| | | | | Cause is set to | |
| | | | | ‘unspecified’otherwise | |
| | | | | it shall be ignored. | |

Redirection Info

| | | |
|---|---|---|
| CHOICE Redirection | MP | |
| Information | | |
| >Frequency info | | Frequency |
| | | info |
| | | 10.3.6.36 |
| >Inter-RAT info | | Inter-RAT |
| | | info |
| | | 10.3.7.25 |

TABLE 3>
RRC Connection Release
Redirection info
This IE is used to redirect the UE to another frequency or other system. A
list of cells may be provided to the UE, where cell selection shall be started.

| Information | | | Type and | Semantics | |
|---|---|---|---|---|---|
| Element/Group name | Need | Multi | reference | description | Version |
| Message Type | MP | | Message Type | | |
| UE information | | | | | |
| elements | | | | | |
| CHOICE | CV-CCCH | | | | REL-5 |
| identity type | | | | | |
| >U-RNTI | | | U-RNTI | | |
| | | | 10.3.3.47 | | |
| >Group identity | | 1 to | | | REL-5 |
| | | <maxUR | | | |
| | | NTIgroup> | | | |
| >>Group release | MP | | Group release | | REL-5 |
| information | | | information | | |
| | | | 10.3.3.14 | | |
| | | | o | | |
| RRC transaction | MP | | RRC | | |
| identifier | | | transaction | | |
| | | | identifier | | |
| | | | 10.3.3.36 | | |
| Integrity check info | CV- | | Integrity | Integrity check info is | |
| | DCCH | | check info | included if integrity | |
| | | | 10.3.3.16 | protection is applied | |
| N308 | CH- | | integer | | |
| | Cell_DCH | | (1 . . . 8) | | |
| Release cause | MP | | Release cause | | |
| | | | 10.3.3.32 | | |
| UE Mobitty State | CV- | | Enumerated | Absence of this IE | REL-7 |
| Indicator | DDCH_MD | | (High- | implies that according | |
| | | | mobility | to [4] the UE shall | |
| | | | Detected) | consider itself being in | |
| | | | | the mobility state the | |
| | | | | UE has maintained in | |
| | | | | CELL_DCH state or | |
| | | | | being not in high- | |
| | | | | mobility state when | |
| | | | | entering in Idle Mode, | |
| | | | | if applicable. | |
| Other information | | | | | |
| elements | | | | | |
| Rplmn information | OP | | Rplmn | | |
| | | | information | | |
| | | | 10.3.8.15 | | |
| Redirection info | OP | | Redirection info | | REL-6 |
| | | | 10.3.3.29 | | |

Redirection Info

| | | |
|---|---|---|
| CHOICE Redirection | MP | |
| Information | | |
| >Frequency Info | | Frequency info |
| | | 10.3.6.36 |
| >Inter-RAT Info | | Inter-RAT info |
| | | 10.3.7.25 |

While the disclosure has been shown and described with reference to certain various embodiments thereof, it will be understood by those skilled in the art that various changes in form and details may be made therein without departing from the spirit and scope of the disclosure as defined by the appended claims and their equivalents.

What is claimed is:

1. A communication method of a mobile terminal in a mobile communication system, the communication method comprising:
requesting a first base station of a first mobile communication system to establish a call connection;
receiving information about a first frequency of an adjacent base station for call redirection from the first base station in response to the call connection request;
searching for one or more frequencies for the call redirection using the information about the first frequency and information about a second frequency of at least one second mobile communication system;
selecting a frequency for the call redirection from among the searched one or more frequencies; and
sending a call connection request to a second base station using the selected frequency.

2. The communication method of claim 1, wherein the information about the second frequency includes information about at least one frequency previously used for a call connection by the mobile terminal.

3. The communication method of claim 1, wherein the information about the second frequency includes information about at least one frequency among frequencies being used by the at least one second mobile communication system.

4. The communication method of claim 1, wherein the first mobile communication system and the at least one second mobile communication system homogeneous mobile communication systems or heterogeneous mobile communication systems each other.

5. The communication method of claim 1, wherein the adjacent base station is a base station of a heterogeneous mobile communication system which is different from the first mobile communication system, and the adjacent base station is selected by the first base station.

6. The communication method of claim 1, wherein the selecting of the frequency comprises selecting a frequency with the highest intensity of reception signal or the best quality of reception signal, from among frequencies searched at the current location of the mobile terminal.

7. The communication method of claim 1, wherein the information about the second frequency comprises frequency information stored in advance in the mobile terminal.

8. The communication method of claim 1, further comprising receiving the information about the second frequency from the first base station.

9. The communication method of claim 1, wherein the call redirection is performed when the mobile terminal receives a message associated with a Radio Resource Control (RRC) connection, the message including the information about the first frequency, from the first base station, and the message associated with the RRC connection is one of an RRC Connection Setup message, an RRC Connection Reject message, and an RRC Connection Release message.

10. The communication method of claim 8, wherein the call redirection is performed when the mobile terminal receives a message associated with a Radio Resource Control (RRC) connection, the message including the information about the first and second frequencies, from the first base station, and the message associated with the RRC connection is one of an RRC Connection Setup message, an RRC Connection Reject message, and an RRC Connection Release message.

11. The communication method of claim 10, wherein the first and second mobile communication systems are homogeneous systems each other, and the information about the first and second frequencies is included in the form of frequency info in the message associated with the RRC connection.

12. The communication method of claim 9, wherein the first and second mobile communication systems are heterogeneous systems each other, and the message associated with the RRC connection is one of the RRC connection reject message and the RRC connection release message, and
the information about the first frequency is included in the form of Inter-RAT Info in Redirection Info included in the message associated with the RRC connection.

13. The communication method of claim 10, wherein the first and second mobile communication systems are heterogeneous systems each other, and the message associated with the RRC connection is one of the RRC connection reject message and the RRC connection release message, and
the information about the first and second frequencies is included in the form of Inter-RAT info in Redirection Info included in the message associated with the RRC connection.

14. A mobile terminal for call redirection in a mobile communication system, the mobile terminal comprising:
a transceiver configured to receive/transmit radio signals from/to a plurality of base stations; and
a controller configured to request a first base station of a first mobile communication system to establish a call connection, to receive information about a first frequency of an adjacent base station for call redirection from the first base station in response to the call connection request, to search for one or more frequencies for the call redirection using the information about the first frequency and information about a second frequency of at least one second mobile communication system, to select a frequency for the call redirection from among the searched one or more frequencies, and to send a call connection request to a second base station using the selected frequency.

15. The mobile terminal of claim 14, wherein the information about the second frequency includes information about at least one frequency previously used for a call connection by the mobile terminal.

16. The mobile terminal of claim 14, wherein the information about the second frequency includes information about at least one frequency among frequencies being used by the at least one second mobile communication system.

17. The mobile terminal of claim 14, wherein the first mobile communication system and the at least one second mobile communication system are homogeneous mobile communication systems or heterogeneous mobile communication systems each other.

18. The mobile terminal of claim 14, wherein the adjacent base station is a base station of a heterogeneous mobile communication system which is different from the first mobile communication system, and the adjacent base station is selected by the first base station.

19. The mobile terminal of claim 14, further comprising a measurer configured to measure the intensity of reception signals of the radio signals,
wherein the controller further controls operation of selecting a frequency with the highest intensity of reception signal or the best quality of reception signal from among frequencies searched at the current location of the mobile terminal.

20. The mobile terminal of claim 14, wherein the information about the second frequency comprises frequency information stored in advance in the mobile terminal.

21. The mobile terminal of claim 14, wherein the controller further controls operation of receiving the information about the second frequency from the first base station.

22. The mobile terminal of claim 14, wherein the controller searches for the frequencies for the call redirection by receiving a message associated with a Radio Resource Control (RRC) connection, the message including the information about the first frequency, from the first base station, and the message associated with the RRC connection is one of an RRC Connection Setup message, an RRC Connection Reject message, and an RRC Connection Release message.

23. The mobile terminal of claim 21, wherein the controller searches for the frequencies for the call redirection by receiving a message associated with a Radio Resource Control (RRC) connection, the message including the information about the first and second frequencies, from the first base station, and the message associated with the RRC connection is one of an RRC Connection Setup message, an RRC Connection Reject message, and an RRC Connection Release message.

24. The mobile terminal of claim 14, wherein, if the first and second mobile communication systems are homogeneous systems each other, the information about the first and second frequencies is included in the form of frequency info in the message associated with the RRC connection.

25. The mobile terminal of claim 14, wherein the first and second mobile communication systems are heterogeneous systems each other, and the message associated with the RRC connection is one of the RRC connection reject message and the RRC connection release message, and
the information about the first frequency is included in the form of Inter-RAT Info in Redirection Info included in the message associated with the RRC connection.

26. The mobile terminal of claim 23, wherein the first and second mobile communication systems are heterogeneous systems each other, and the message associated with the RRC connection is one of the RRC connection reject message and the RRC connection release message, and
the information about the first and second frequencies is included in the form of Inter-RAT info in Redirection Info included in the message associated with the RRC connection.

27. A communication method of a base station in a mobile communication system, the communication method comprising:
receiving a call request for establishing a call connection from a mobile terminal; and
transmitting information about a first frequency of an adjacent base station for call redirection of the mobile terminal and information about a second frequency of at least one mobile communication system, to the mobile terminal, if an abnormal state incapable of establishing the call connection has occurred.

28. The communication method of claim 27, wherein the at least one mobile communication system and the mobile communication system that has received the call request from the mobile terminal are homogeneous mobile communication systems or heterogeneous mobile communication systems each other.

29. The communication method of claim 27, wherein the adjacent base station is a base station of a heterogeneous mobile communication system which is different from the mobile communication system which has received the call request from the mobile terminal, and the adjacent base station is selected by the base station.

30. The communication method of claim 27, wherein the call redirection is performed when the base station transmits a message associated with a Radio Resource Control (RRC) connection, the message including the information about the first and second frequencies, to the mobile terminal, and the message associated with the RRC connection is one of an RRC Connection Setup message, an RRC Connection Reject message, and an RRC Connection Release message.

31. The communication method of claim 30, wherein the mobile communication system which has received the call request and the at least one mobile communication system are homogeneous systems, and the information about the first and second frequencies is included in the form of frequency info in the message associated with the RRC connection.

32. The communication method of claim 30, wherein the mobile communication system which has received the call request and the at least one mobile communication system are heterogeneous systems, and the message associated with the RRC connection is one of the RRC Connection Reject message and the RRC Connection Release message, and
the information about the first and second frequencies is included in the form of Inter-RAT Info in Redirection Info included in the message associated with the RRC connection.

33. A base station of a mobile communication system, the base station comprising:
a transceiver configured to receive/transmit radio signals from/to a mobile terminal; and
a controller configured to receive a call request for establishing a call connection from the mobile terminal, and to control operation of transmitting information about a first frequency of an adjacent base station for call redirection of the mobile terminal and information about a second frequency of at least one second mobile communication system, to the mobile terminal, if an abnormal state incapable of establishing the call connection has occurred.

34. The base station of claim 33, wherein the at least one mobile communication system and the mobile communication system that has received the call request from the mobile terminal are homogeneous mobile communication systems or heterogeneous mobile communication systems each other.

35. The base station of claim 33, wherein the adjacent base station is a base station of a heterogeneous mobile communication system which is different from the mobile communication system which has received the call request from the mobile terminal, and the adjacent base station is selected by the base station.

36. The base station of claim 33, wherein the controller controls operation of transmitting a message associated with a Radio Resource Control (RRC) connection for the call redirection of the mobile terminal, the message including the information about the first and second frequencies, and the message associated with the RRC connection is one of an RRC Connection Setup message, an RRC Connection Reject message, and an RRC Connection Release message.

37. The base station of claim 36, wherein the mobile communication system that has received the call request and the at least one mobile communication system are homogeneous systems, and the information about the first and second frequencies is included in the form of frequency info in the message associated with the RRC connection.

38. The base station of claim 36, wherein the mobile communication system that has received the call request and the at least one mobile communication system are heterogeneous systems each other and the message associated with the RRC connection is one of the RRC Connection Reject message and the RRC Connection Release message, and
the information about the first and second frequencies is included in the form of Inter-RAT Info in Redirection Info included in the message associated with the RRC connection.
